(19) United States
(12) Patent Application Publication
(10) Pub. No.: US 2014/0251110 A1
(43) Pub. Date: Sep. 11, 2014

(54) MULTI-SIDE BERRY PIERCING APPARATUS AND METHOD

(71) Applicant: Gerald D. Miller, Kalamazoo, MI (US)

(72) Inventor: Gerald D. Miller, Kalamazoo, MI (US)

(21) Appl. No.: 14/173,390

(22) Filed: Feb. 5, 2014

Related U.S. Application Data
(60) Provisional application No. 61/774,202, filed on Mar. 7, 2013.

(51) Int. Cl. A23N 15/02

(52) U.S. Cl. CPC A23N 15/02
USPC 83/866

(57) ABSTRACT

A machine includes a frame, a conveyor with a plurality of open-top bottom-apertured recesses for receiving, conveying and dropping skin-containing berries. Upper and lower needle assemblies are supported on the frame above and below the conveyor. Each needle assembly includes a plurality of needles with five-star-knife-edged sharp tips and an actuator mechanism for oscillatingly moving the needles as the recesses pass the needles, the needles being movable between an extended position where the sharp tips penetrate opposing sides of the skin of the berries but with a stroke causing the tips to only penetrate partially into an interior of the berries causing star-shaped slit patterns. The actuator mechanism also moves the needles to a retracted position where the sharp tips are fully retracted. A related method is provided for piercing multiple sides of the skin of berries without unacceptably damaging the appearance or shape or internal mass of the berries.

This application claims benefit under 35 USC section 119(e) of provisional application Ser. No. 61/774,202, filed Mar. 7, 2013, entitled MULTI-SIDED BERRY PIERCING MACHINE, the entire contents of which are incorporated herein by reference.

### BACKGROUND

The present invention relates to an apparatus and method for piercing multiple sides of skinned berries, such as cranberries, cherries, blueberries, and the like, doing so without damaging or bruising the berries' shape or internal mass (called “meat” herein).

Berries are often infused with a sugar solution. However, the skin of berries is a barrier, such that it must be pierced or removed to facilitate the infusion process. This is difficult to do, particularly on a high volume basis, without damaging the meat of the fruit and/or without damaging a shape or appearance of the berries. Cranberries in particular have a relatively stiff internal meat that tends to split or fracture when a needle penetrates the cranberry's skin, and it is unacceptable to berry-product producers (and customers) to have a significant percentage of cranberries split and/or have pieces break away.

Thus, an improved machine and related process are desired capable of handling high volumes of berries with a high degree of consistency, including piercing multiple sides of berry skins without ripping or tearing the berry skin in an unacceptable way that adversely affects its appearance, and including piercing the skin without bruising or unacceptably damaging the berries' internal meat.

### SUMMARY OF THE PRESENT INVENTION

In one aspect of the present invention, a machine is provided for piercing the skin of berries without unacceptably damaging the appearance or shape or internal mass of the berries. The machine includes a frame, a conveyor with a plurality of open-top recesses for receiving individual ones of the berries, and for conveying and then dropping the berries, each recess having a through hole, and upper and lower needle assemblies supported on the frame above and below the conveyor, each needle assembly including a plurality of needles having a sharp tip oriented toward the conveyor. The machine further includes an actuator mechanism for oscillatingly moving the needles as the holes pass the needles, the needles being movable between an extended position where the sharp tips penetrate opposing sides of the skin of the berries but only penetrate partially into an interior of the berries, and a retracted position where the sharp tips are fully retracted from the berries.

In another aspect of the present invention, a method is provided for piercing the skin of berries without unacceptably damaging the appearance or shape or internal mass of the berries. The method includes steps of providing a conveyor having a plurality of open-top recesses for receiving individual ones of the berries, supplying berries to the conveyor and conveying the berries, and simultaneously piercing upper and lower sides of the berries using needles with sharp tips.

In another aspect of the present invention, a machine for multi-side piercing the skin of berries includes a conveyor for automatically conveying individual berries, a plurality of needle assemblies, each including a plurality of needles having a sharp tip oriented toward the conveyor, and an actuator mechanism for oscillatingly moving the needles between an extended position where the sharp tips penetrate more than one side of the skin of the berries but only penetrate partially into an interior of the berries, and a retracted position where the sharp tips are fully retracted from the berries.

In another aspect of the present invention, a method for piercing the skin of berries on multiple sides, comprises steps of providing a conveyor conveying berries, and simultaneously piercing multiple sides of each of the berries using needles with sharp tips facing in different directions.

In a narrower aspect of the above method, the method includes providing at least two banks of the needles, and oscillating the needles in the at least two banks to pierce the multiple sides of the berries as the conveyor conveys the berries along a path.

These and other aspects, objects, and features of the present invention will be understood and appreciated by those skilled in the art upon studying the following specification, claims, and appended drawings.

### BRIEF DESCRIPTION OF DRAWINGS

FIG. 1 is a front view of a downstream side of a machine embodying the present invention.

FIGS. 2-3 are side cross sections of FIG. 1, FIG. 2 showing the top and bottom needles extended and double-piercing opposing sides of cranberries in its conveyor, and FIG. 3 showing the top and bottom needles retracted.

FIG. 4 is an enlarged view of FIG. 2, focusing on the conveyor with berries therein and with the top and bottom banks with needles extended.

FIG. 5 is a view similar to FIG. 2 but showing the oscillating drives for the top and bottom banks of needles.

FIGS. 6, 6A, 6B are perspective, side and end views of the star-shaped sharpened end of a berry-skin-piercing needle.

FIG. 7 is a perspective view of a cranberry pierced on opposing sides (i.e. pierced on multiple sides) by the apparatus in FIG. 1.

### DETAILED DESCRIPTION OF PREFERRED EMBODIMENTS

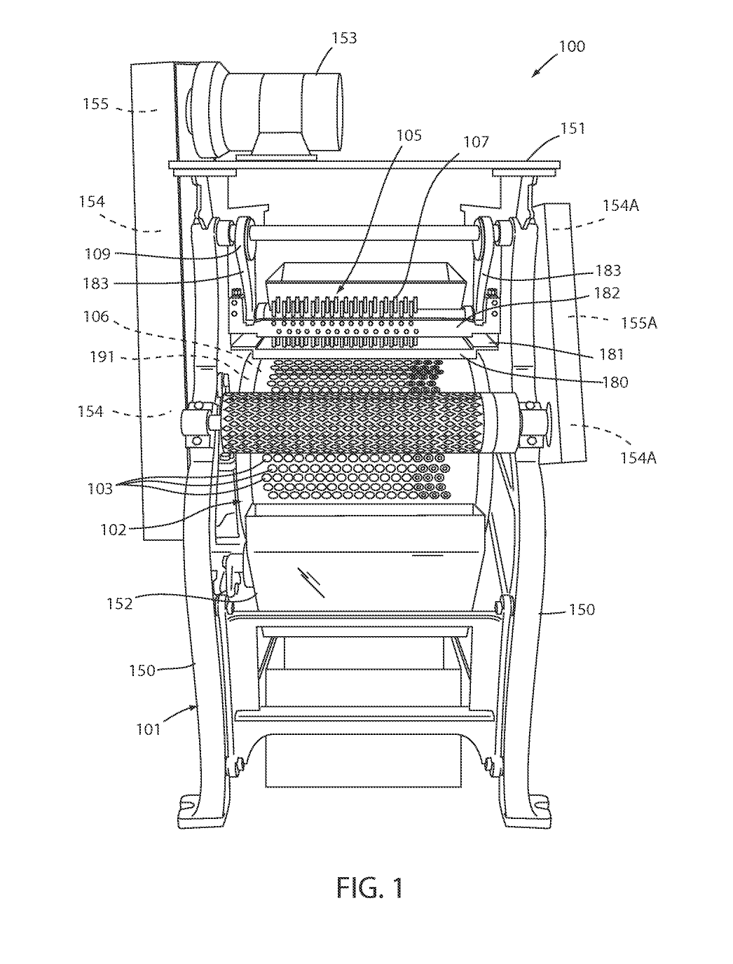

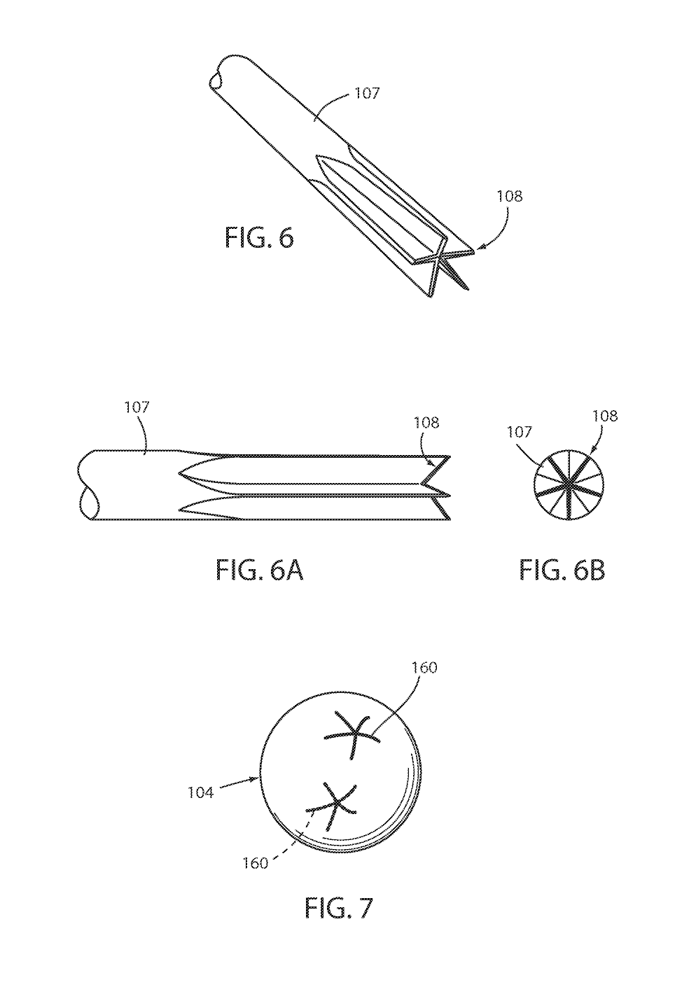

A multi-side berry piercing apparatus/machine 100 (FIG. 1) includes a frame 101, a conveyor 102 (such as a cylindrical drum or belt) with a plurality of open-top bottom-apertured recesses 103 for receiving, conveying and then dropping skin-containing berries 104. Notably, the berries 104 can be cranberries or can be any skinned berry, such as blueberries, cherries, and the like. Upper and lower needle assemblies 105 and 106 are supported on the frame 101 above and below the conveyor 102. (The term “below” is intended to cover the illustrated arrangement in FIGS. 1-3 if it is a drum conveyor, where the lower needle assembly 106 is inside the drum, but also is intended to cover an arrangement using an elongated horizontal conveyor where the assemblies 105 and 106 are above and below the elongated horizontal conveyor.) Each needle assembly includes a plurality of needles 107 (i.e. “banks” of needles), each with five-star-knife-edged sharp tips 108 (FIGS. 6-6B) oriented toward the conveyor 102. Notably, the needles are arranged in rows, and it is contemplated that more or less rows can be included in the apparatus, depending on functional requirements of a particular machine. The tips 108 are defined by five knife edges that begin as protruding points at a circumference of the needle's shaft and that extend inwardly at about 45 degrees to a common center point recessed into an end of the needle shaft's end. It is noted that a shape of the knife edges can be important to successfully piercing the berry's skin without damaging a shape or meat of the berry, depending of course on the particular type berry being pierced.

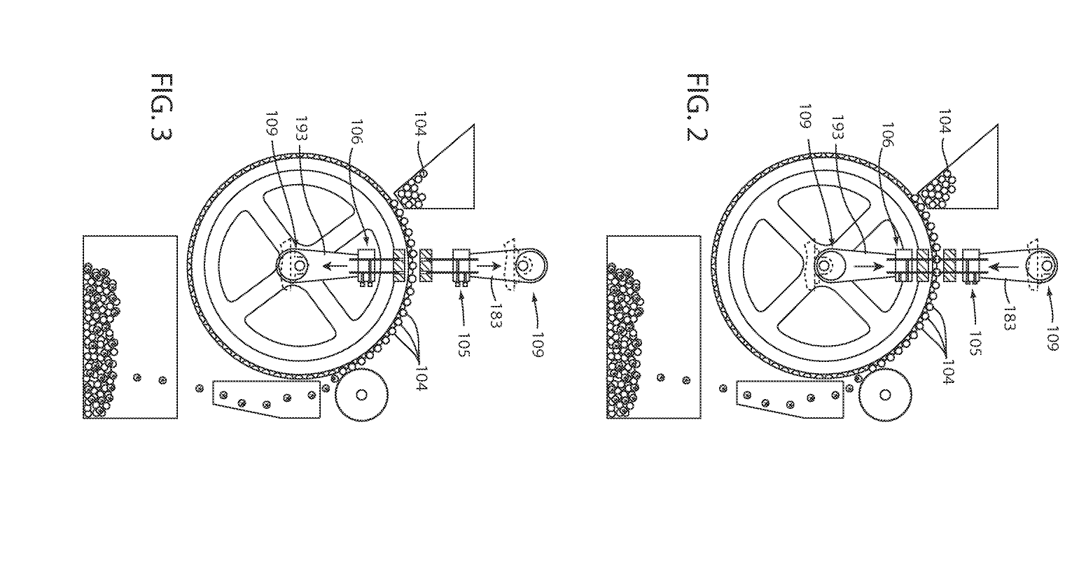

In the illustrated machine 100, an actuator mechanism 109 (also called “oscillator”) oscillatingly moves the needles 107 as the recesses pass the needles 107, with the needles 107 oscillatingly moving between an extended position where the sharp tips 108 penetrate opposing sides of the skin of the berries 104 (FIGS. 2 and 4) and a retracted position (FIG. 3) where the tips 108 clear the berries 104. Notably, a stroke of the needles 107 causes the tips 108 to only penetrate partially into an interior of the berries (such as less than 50% penetration, or more particularly between about 25% and 40% penetration, depending on the berry and the need to deep penetration to assure slicing of the berry skin). A shape of the knife-edges forming the tips 108 causes a star-like slit 160 in the berry 104. The particular shape of the tips 108 helps contain the berry as the tip 108 enters the berry 104, thus assisting in keeping the berry whole during the piercing process. The actuator mechanism 109 also moves the needles 107 to a retracted position where the sharp tips 108 are fully retracted from the berries 104, thus allowing the berries 104 to be conveyed away to a collection site. A blow-off or scrubber 109 can be used to assure that all berries 104 are removed from the recesses before the conveyor recesses cycle to an upstream location to repeat the skin-piercing activity. The related method includes piercing multiple sides (such as opposing sides) of the skin of berries 104 without unacceptably damaging the appearance or shape or internal mass of the berries 104.

It is noted that several components of the present innovative machine 100 do not need a detailed description since they will be recognized by persons skilled in this art. Specifically, the present illustrated apparatus 100 uses several components sometimes used in automated cherry-pitting machines having a cylindrical conveyor with recesses adapted to receive cherries. The automated cherry-pitting machine has a drum conveyor that conveys the cherries past a top bank of oscillating needles, which force cherry pits downwardly into a center of the cylindrical conveyor. Thus, some components such as the oscillating drive, the machine frame, the conveyor including the berry in-feed and berry collection and berry dumping aspects of the conveyor, and their interrelationship do not require a detailed description for artisans skilled in this art to understand the present disclosure.

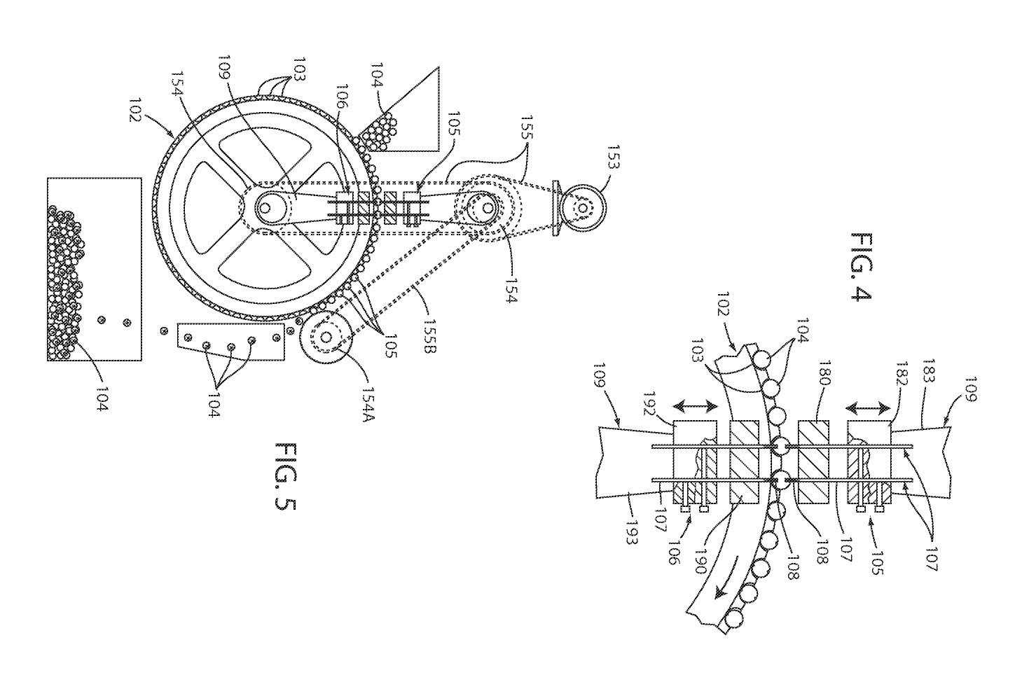

The illustrated frame 101 (FIG. 1) includes upright side frames 150 connected by a top frame cross member 151 and supporting bearings/rollers 152 that support rotation of the illustrated drum conveyor 102. A motor 153 is supported on the cross member 151, and a plurality of pulleys and gears 154 (FIG. 5) are driven by first drive chain(s) 155 that extend from the motor 153 around the various gears 154 on one side, and also includes a second drive chain 155A on the opposite side that drives additional gears 154A. The gears 154 and 154A are connected to various components of the machine 100 for operating the components in timed sequence, including rotating the drum conveyor 102, and motivating the eccentric actuator 156 (part of the actuator mechanism 109) for the upper and lower needle assemblies 105 and 106. The timing of needle extension and retraction is so that the needles 107 extend at an appropriate time to extend into and pierce opposing sides of individual berries 104 and so the needles 107 retract without being bent or damaged by the moving conveyor 102.

As noted above, cylindrical conveyors with berry-conveying recesses, including where recesses are formed by resilient rubber in wells in the conveyor belts, are well known, and a detailed description of the present conveyor is not believed necessary. It is noted that the present conveyor included recesses shaped to process cranberries having a fruit size of between approximately 14 mm to 19 mm, and to have top and bottom needles 107 that have a same diameter five-star arrangement of knife edges. The illustrated conveyor 102 is a drum or cylinder conveyor, and as noted above has a plurality of open-top bottom-apertured recesses 103 for receiving, conveying and then dropping skin-containing berries 104.

The lower needle assembly 106 is not unlike the upper needle assembly 105, however it is positioned inside the drum conveyor 102 as shown in FIGS. 2-4 and as discussed below. Both needle assemblies 105 and 106 are supported on the frame 101 above and below the skin-piercing station of the conveyor 102/machine 100. The illustrated needle assemblies 105 and 106 (each with needles 107) and oscillating mechanisms 109 were made so that the needle tips 108 each penetrate a surface of the individual cranberry berries 104 by about 3/16 inch (about 4-6 mm, or more preferably about 5 mm), leaving a star-shaped five-pointed slit 160 at each entry point. Notably, the illustrated sharp tips 108 have five knife edges that converge on a center point, with outer edges of the knife edges extending longer that the center point, as illustrated in FIGS. 6-6B. A diameter of the needles 107 are sized to be somewhat less than a diameter of the smallest berry in the lot of berries being pierced, such as about 35% to 65% of the smallest berry's diameter. For example, for cranberries having a diameter of 14 mm to 19 mm, a diameter of the needle can be about 8 mm to 11 mm, or more preferably about 9 mm to 10 mm.

As will be understood by skilled artisans, each needle assembly 105 and 106 includes a plurality of needles 107 with five-star-knife-edged sharp tips 108 oriented toward the conveyor 102, and includes an eccentric actuator mechanism 109 for oscillatingly moving the needles 107 as the recesses 103 pass under the needles 107. In particular, the upper needle assembly 105 (FIGS. 1-2) includes a stationary bed 180 supported by side brackets 181 on the frame sides 150. The lower needle assembly 106 similarly includes a stationary bed 190 supported by side brackets 191 on the frame sides 150. The upper needle assembly 105 further includes an oscillatingly movable plate 182 to which downwardly-facing needles 108 are affixed, and to which the oscillating drive arm 183 is attached. The lower needle assembly 106 further includes an oscillatingly movable plate 192 to which upwardly-facing needles 108 are affixed, and to which the oscillating drive arm 193 is attached.

The needles 107 are movable between an extended position where the sharp tips 108 enter a particular recess in the conveyor and then penetrate opposing sides of the skin of the berries 104, but with a stroke of the needles 107 causing the tips 108 to only penetrate partially into an interior of the berries 104. In particular, the penetration is short of half a distance into the berry 104 so that the opposing needles don't collide. The actuator mechanism 156 also moves the needles 107 to a retracted position where the sharp tips 108 are fully retracted from the berries 104, with the tips 108 being partially withdrawn from the recesses in the conveyor to assure release from the associated berry 104.

FIGS. 6-6B show an exemplary needle 107 and FIG. 7 shows an exemplary multi-side-pierced cranberry 104, including the five-point star-like slits 160 on opposite sides from being pierced by the opposing needle tips 108. The present machine 100 has tested to be particularly effective at piercing cranberries in high volume on opposing sides, leaving two five-pointed star-shaped incisions 160 in each berry 104, without unacceptably damaging the meat or interior substance of the berries 104. The present machine 100 has proven capable of processing about 1500 pounds per hour of cranberries, but it is contemplated that faster or slower processing speeds can be used. Advantageously, the present machine 100 is relatively straight-forward and easy to install and operate. The slits 160 are particularly advantageous so that the berries 104 can be later processed such as by infusing sugar into the berry, with each slit providing unrestricted access of the sugar solution into the berry 104. The illustrated slits 160 are relatively large and comprise a total linear length that provides great access to the interior of the berries 104, and further the slits 160 are reliably and accurately formed without damaging the berries' appearance or internal material, and without ripping, tearing, or otherwise unacceptably damaging the skin of the berries 104.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A machine for piercing the skin of berries without unacceptably damaging the appearance or shape or internal mass of the berries, comprising:
a frame;
a conveyor with a plurality of open-top recesses for receiving individual ones of the berries, and for conveying and then dropping the berries, each recess having a through hole;
upper and lower needle assemblies supported on the frame above and below the conveyor, each including a plurality of needles having a sharp tip oriented toward the conveyor and an actuator mechanism for oscillatingly moving the needles as the holes pass the needles, the needles being movable between an extended position where the sharp tips penetrate opposing sides of the skin of the berries but only penetrate partially into an interior of the berries, and a retracted position where the sharp tips are fully retracted from the berries.

2. The machine defined in claim 1, wherein the conveyor is a drum conveyor.

3. The machine defined in claim 1, wherein the sharp tip of each needle has knife edges forming a star-shape.

4. The machine defined in claim 3, wherein the knife edges each have a protruding tip located adjacent a circumference of a shaft of the needle and with the knife edges extending at about 45 degrees inwardly to a common center point recessed into an end of the shaft.

5. A method for piercing the skin of berries without unacceptably damaging the appearance or shape or internal mass of the berries, comprising steps of:
providing a conveyor having a plurality of recesses for receiving individual ones of the berries;
supplying berries to the conveyor and conveying the berries; and
simultaneously piercing upper and lower sides of the berries using needles with sharp tips.

6. A machine for multi-side piercing the skin of berries, comprising:
a conveyor for automatically conveying individual berries; and
a plurality of needle assemblies, each including a plurality of needles having a sharp tip oriented toward the conveyor; and
an actuator mechanism for oscillatingly moving the needles between an extended position where the sharp tips penetrate more than one side of the skin of the berries but only penetrate partially into an interior of the berries, and a retracted position where the sharp tips are fully retracted from the berries.

7. A method for piercing the skin of berries on multiple sides, comprising steps of:
providing a conveyor conveying berries; and
simultaneously piercing multiple sides of each of the berries using needles with sharp tips facing in different directions.

8. The method of claim 7, including providing at least two banks of the needles, and oscillating the needles in the at least two banks to pierce the multiple sides of the berries as the conveyor conveys the berries along a path.
